(19) United States
(12) Patent Application Publication
(10) Pub. No.: US 2014/0119205 A1
(43) Pub. Date: May 1, 2014

(54) Hybrid multi-cell channel estimation

(71) Applicant: BROADCOM CORPORATION, Irvine, CA (US)

(72) Inventors: Baoguo Yang, Saratoga, CA (US); Joonsuk Kim, Saratoga, CA (US); Lek (Sirikiat) Ariyavisitakul, Alpharetta, GA (US); Nelson R. Sollenberger, Farmingdale, NJ (US)

(73) Assignee: BROADCOM CORPORATION, IRVINE, CA (US)

(21) Appl. No.: 13/661,261

(22) Filed: Oct. 26, 2012

(51) Int. Cl. H04B 15/00; H04W 24/00

(52) U.S. Cl. 370/252

(57) ABSTRACT

Hybrid multi-cell channel estimation. At least two different operational modes associated with performing multi-cell channel estimation are combined and performed within different respective iterations of processing in order to generate a multi-cell channel estimate. A device, including at least one wireless interface to support communications with at least one other device and also including at least one processor to process signals received by or to be transmitted from, is operative to generate a multi-cell channel estimate corresponding to two or more respective cells with which the device may communicate. A first operational mode corresponds to time domain (TDOM) based per-tap serial interference cancellation (SIC), and a second operational mode corresponds to frequency domain (FDOM) based per-cell SIC. One implementation operates with no more than one iteration of TDOM based per-tap SIC, and no more than two iterations of FDOM based per-cell SIC.

### BACKGROUND OF THE INVENTION

1. Technical Field of the Invention

The invention relates generally to communication systems; and, more particularly, it relates to channel estimation within such communication systems operative using various cells.

2. Description Of Related Art

Data communication systems have been under continual development for many years. While there are a variety of different types of communication systems, certain types of communication systems may include one or more mobile devices that interact with one or more other mobile devices and/or one or more stationary devices. For example, in the context of cellular communication systems, a cellular telephone or other mobile device operative to interact with the cellular system may interact with multiple respective cells therein. Currently, the state-of-the-art does not provide an adequate means by which channel estimation may be made for such multiple cell configurations in a manner that is acceptably accurate, fast, and which may be implemented sufficiently cost-effective for deployment across a variety of different types of devices.

### BRIEF DESCRIPTION OF THE SEVERAL VIEWS OF THE DRAWINGS

FIG. 1 and FIG. 2 illustrate various embodiments of communication systems.

FIG. 3 illustrates an embodiment of a communication system including various wireless communication devices (e.g., stationary, mobile, etc.).

FIG. 4 illustrates an embodiment of a wireless communication device operative to support communications with two or more cells.

FIG. 5 illustrates an embodiment of a wireless communication device operative to generate a multi-cell channel estimate based corresponding to two or more cells.

FIG. 6, FIG. 7, and FIG. 8 are diagrams illustrating embodiments of methods for operating one or more wireless communication devices.

### DETAILED DESCRIPTION OF THE INVENTION

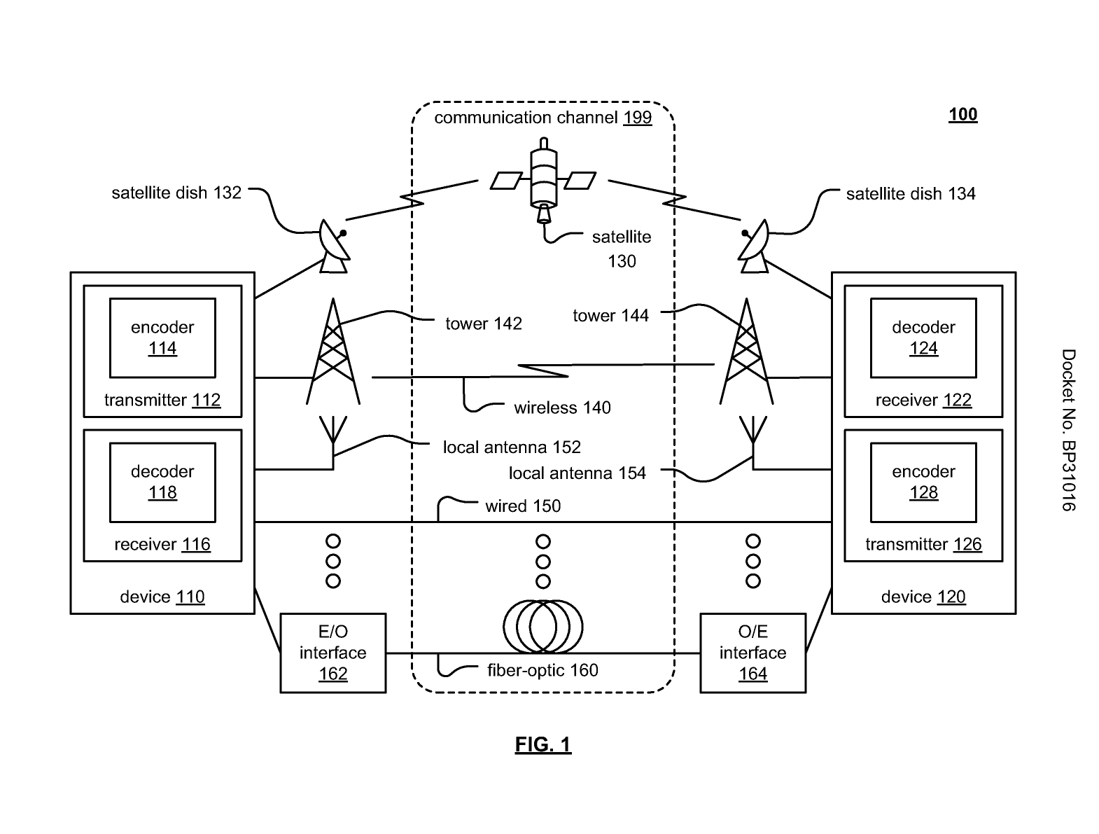

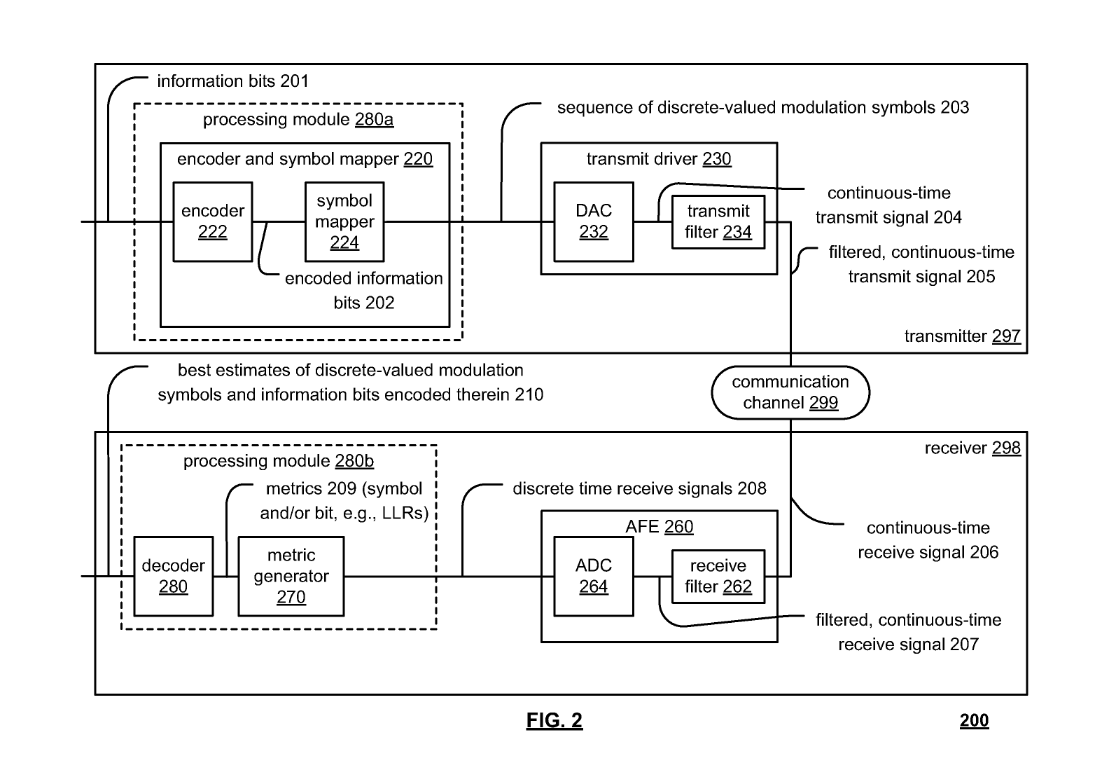

Within communication systems, signals are transmitted between various communication devices therein. The goal of digital communications systems is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

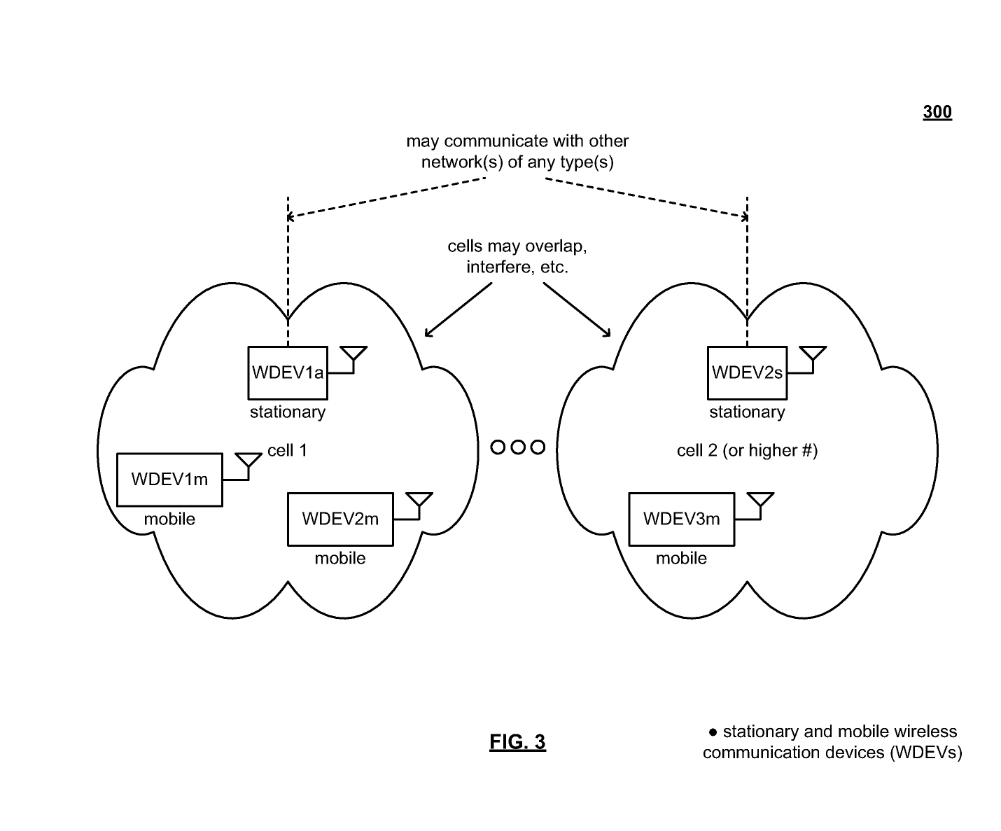

FIG. 1 and FIG. 2 illustrate various embodiments of communication systems, 100, and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

It is noted that such communication devices 110 and/or 120 may be stationary or mobile without departing from the scope and spirit of the invention. For example, either one or both of the communication devices 110 and 120 may be implemented in a fixed location or may be a mobile communication device with capability to associate with and/or communicate with more than one network access point (e.g., different respective access points (APs) in the context of a mobile communication system including one or more wireless local area networks (WLANs), different respective satellites in the context of a mobile communication system including one or more satellite, or generally, different respective network access points in the context of a mobile communication system including one or more network access points by which communications may be effectuated with communication devices 110 and/or 120.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299). It is noted that any respective communications herein between different respective devices may be effectuated using any communication link, network, media, means, etc. including those described with reference to FIG. 1 and their equivalents.

Herein, improved multi-cell channel estimation for TD-synchronous code division multiple access (S-CDMA) is presented that provide for better performance when compared to prior art approaches in terms of performance, complexity, and other factors. A preferred embodiment of such multi-cell channel estimation is described with reference to FIG. 8, and other various aspects, embodiments, and/or their equivalents, of the invention are also described herein.

Generally speaking, a combination approach or a hybrid approach of performing multi-cell channel estimation. For example, both per tap and per cell interference cancellation are performed to generate a multi-cell channel estimate. In one embodiment, serial interference cancellation (SIC) may be performed in accordance with each of a per tap and per cell basis to generate a multi-cell channel estimate. For example, to effectuate operation herein, such operation may be viewed of basically consisting of two parts: (1) single cell channel estimation and (2) interference cancellation.

Such per tap and per cell may be implemented and viewed as being performed as an iterative channel estimation approach. As will be understood herein, iteration convergence and convergence speed are improved using the approach for iterative channel estimation in accordance with such a combination approach or a hybrid approach. Also, the computation complexity for multi-cell channel estimation is reduced using such a combination approach or a hybrid approach.

Different respective types of SIC are employed at different iteration stages herein to make provided for relatively faster convergence in generating a multi-cell channel estimate when compared to prior art approaches. In addition, individual cell channel estimation accuracy, which may be improved in accordance with any one or more of the various aspects, embodiments, and/or their equivalents, of the invention, can provide for improved convergence speed in generating a multi-cell channel estimate when compared to prior art approaches. For example, the individual cell channel estimation accuracy in any given iteration of SIC may be improved in accordance with any one or more of the various aspects, embodiments, and/or their equivalents, of the invention.

All the single cell channel estimation techniques described herein operate to ensure good single cell channel estimation performance. For example, in order to reduce channel estimation complexity, fast Fourier transform (FFT)/inverse fast Fourier transform (IFFT) may be employed as much as possible to effectuate transformation between the frequency and time domains.

FIG. 3 illustrates an embodiment 300 of a communication system including various wireless communication devices (e.g., stationary, mobile, etc.). As may be seen the district this diagram, a communication system may include a number of different respective devices. For example, within the context of a cellular system, a number of mobile devices may be implemented therein, and a number of stationary devices (e.g., cellular towers, base stations, etc.) may also be limited therein. As the reader will understand, a mobile communication device may be transported to different respective portions of communication system. In addition, any given device within the system may interact with different respective cells that may be supported and operated by different respective devices. As one example, different respective cellular towers may provide coverage within a same area, an overlapping area, etc.

To perform appropriate interference cancellation within such a communication system, appropriate channel estimation should be performed by a given device. In such an implementation including more than one cell, appropriate multi-cell channel estimation should be performed to effectuate interference cancellation. Also, it is noted that different respective devices within the system may also communicate with one or more other types of networks, devices, etc. For example, a stationary wireless communication device may also be coupled are connected to one or more other devices or networks via one or more non-wireless communication means (e.g., wired, optical, etc.) without departing from the scope and spirit of the invention. In addition, a given mobile communication device may at times be coupled are connected to one or more other devices or networks via one or more non-wireless communication means (e.g., wired, optical, etc.) without departing from the scope and spirit of the invention.

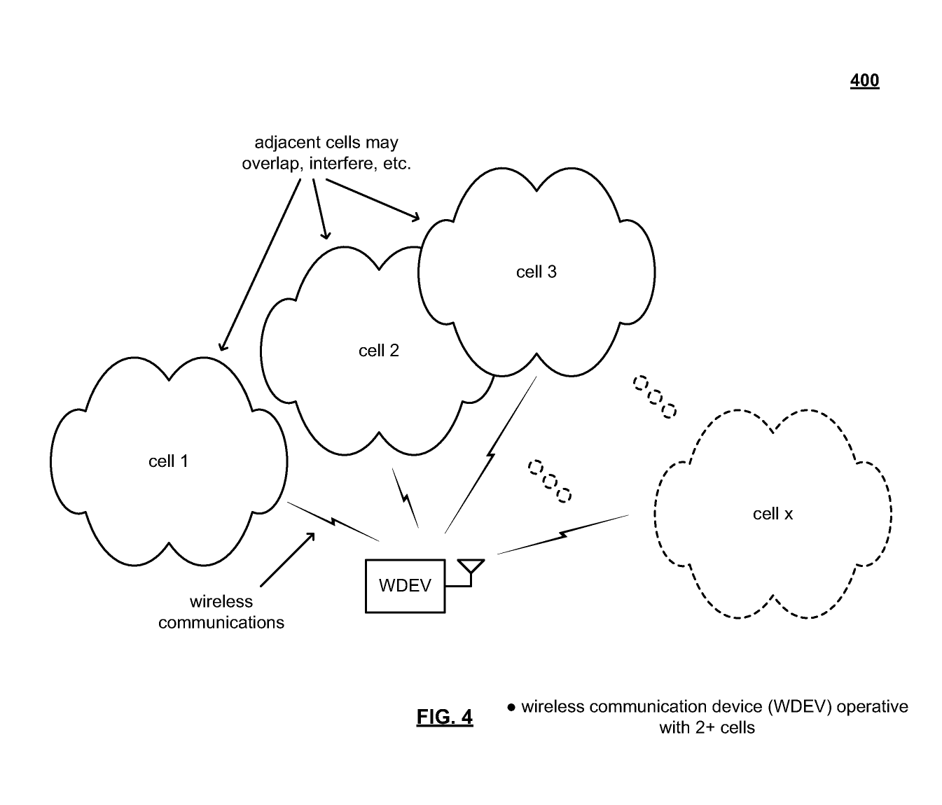

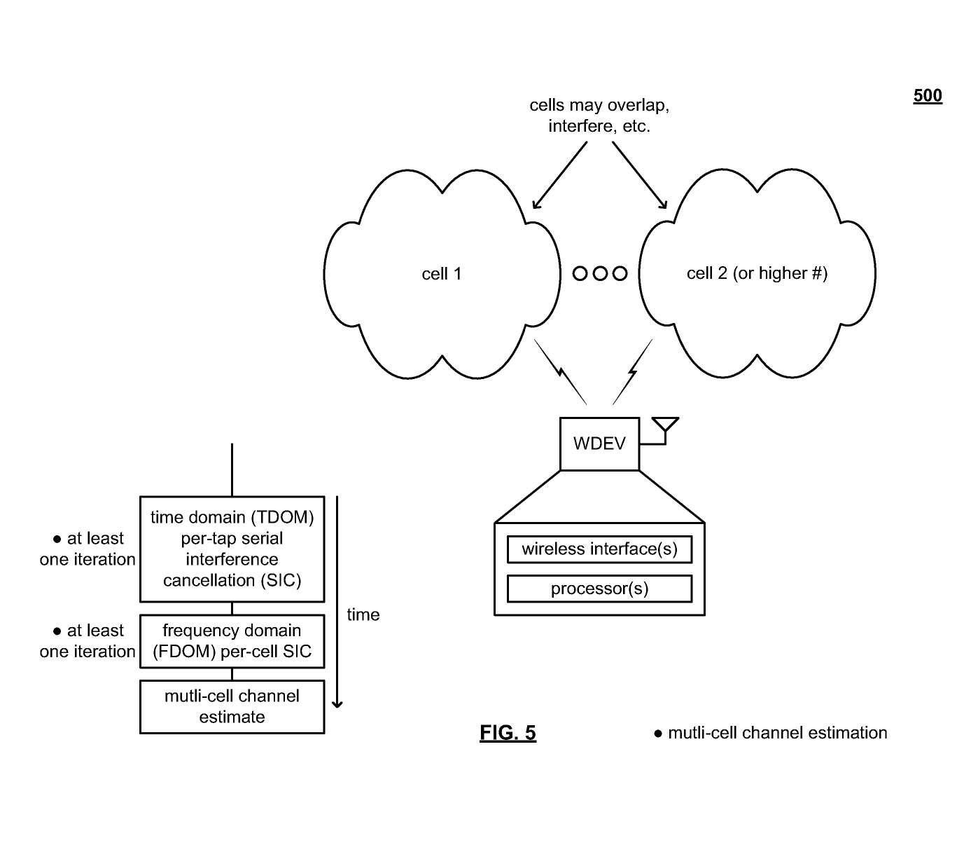

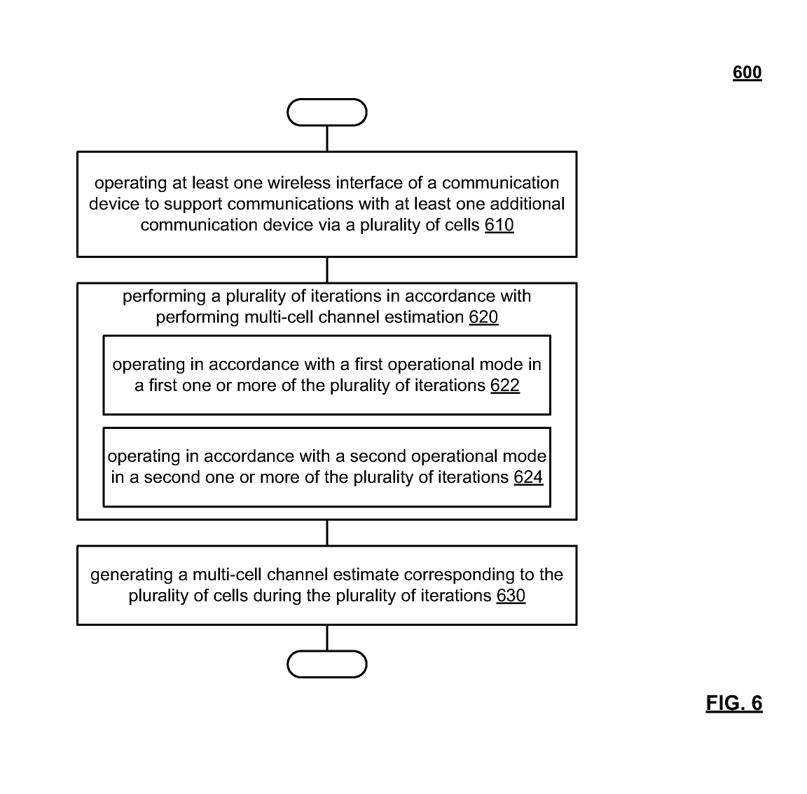

FIG. 4 illustrates an embodiment 400 of a wireless communication device operative to support communications with two or more cells. This diagram also illustrates how a given wireless communication device may be operative to support communications in accordance with more than one cell. For example, wireless communications may be supported using a wireless communication device with a first cell, second cell, and so on up to and including any desired number of cells.

As a reader will understand, to support effective communications within such a system, including performing appropriate interference cancellation within such systems, appropriate and accurate channel estimation should be performed. For example, in such a context of multiple respective cells that may overlap, interfere, etc.

with one another, appropriate multi-channel estimation should be performed in order to generate an accurate channel estimate that may be used for interference cancellation and acceptable performance of a device operating within such a communication system.

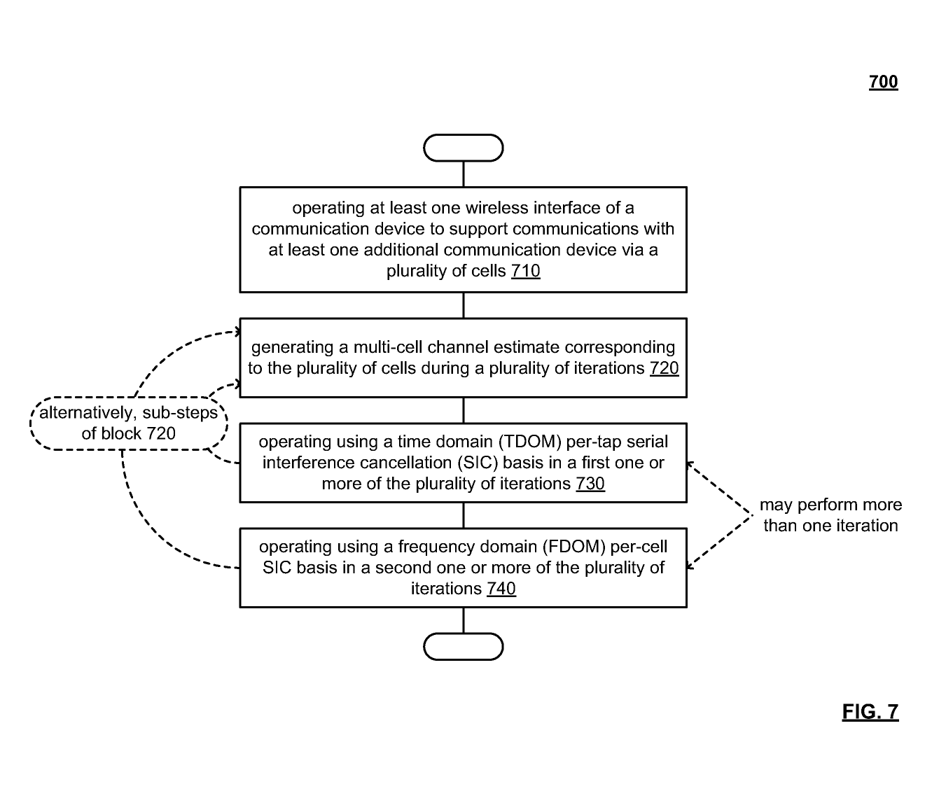

FIG. 5 illustrates an embodiment 500 of a wireless communication device operative to generate a multi-cell channel estimate based corresponding to two or more cells. As shown within this diagram, a given device, such as a wireless communication device, may include one or more wireless interfaces and one or more processors therein. To effectuate generation of an appropriate multi-cell channel estimate corresponding to two or more cells with which a given communication device may interact, different respective types of channel estimation are employed within different respective iterations in order to generate a multi-cell channel estimate.

For example, when considering the generation of a multi-cell channel estimate as a function of time, different respective iterations of calculations are performed. During a first at least one iteration, time domain (TDOM) based per-tap serial interference cancellation (SIC) is performed. Then, during a second least one iteration, frequency domain (FDOM) based per-cell SIC is performed. As may be understood, within such a wireless communication device, at least one wireless interfaces implemented to effectuate communications with one or more other wireless communication devices and/or stationary devices, and one or more processors within the device is operative to perform processing of signals received by the device and/or to be transmitted from the device. In accordance with generating a multi-cell channel estimate, processing of at least one signal received by the device via at least one wireless interface is performed.

In at least one embodiment, no more than one iteration of time domain (TDOM) based per-tap serial interference cancellation (SIC) is performed, and no more than two iterations of frequency domain (FDOM) based per-cell SIC are performed. In alternate embodiments, different respective numbers of iterations of each of the respective types of processing may be performed without departing from the scope and spirit of the invention.

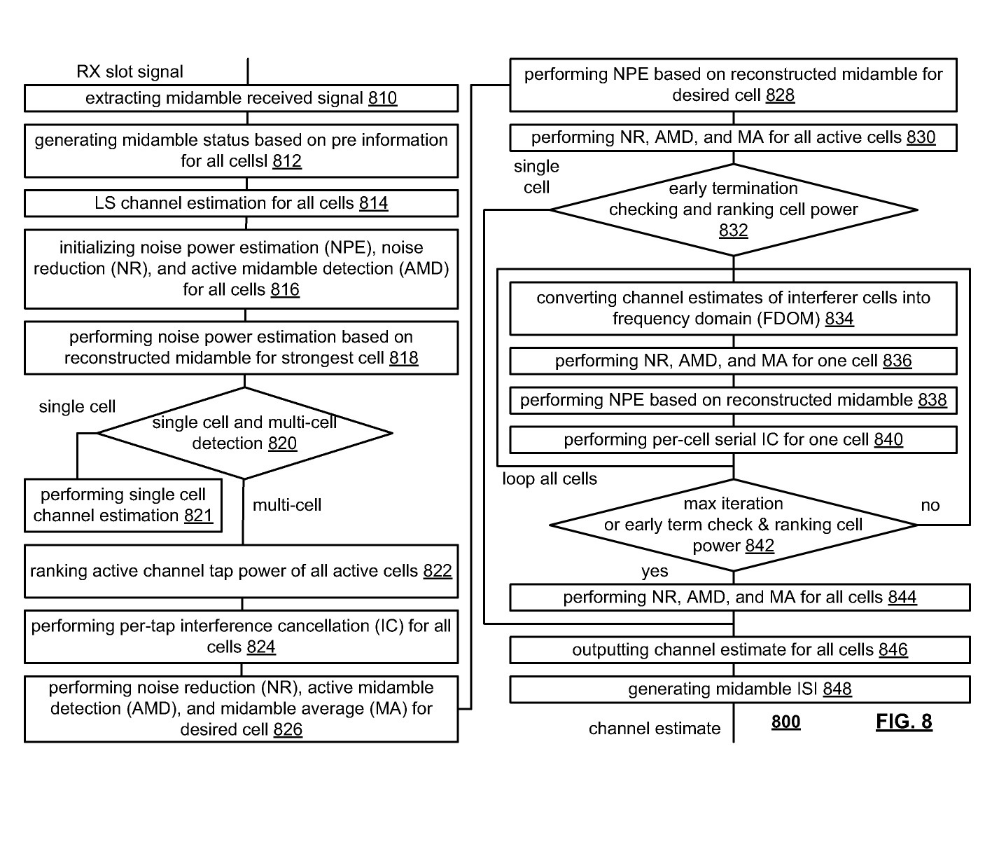

FIG. 6, FIG. 7, and FIG. 8 are diagrams illustrating embodiments of methods for operating one or more wireless communication devices.

Referring to method 600 of FIG. 6, the method 600 begins by operating at least one wireless interface of a communication device to support communications with at least one additional communication device via a plurality of cells, as shown in a block 610.

The method 600 continues by performing a plurality of iterations in accordance with performing multi-cell channel estimation, as shown in a block 620.

In certain embodiments, the operation associated with the block 620 operates in accordance with a first operational mode in a first one or more of the plurality of iterations, as shown in a block 622. Also, the operation associated with the block 620 may operate in accordance with a second operational mode in a second one or more of the plurality of iterations, as shown in a block 624. It is also noted that other respective operational modes may alternatively be employed within other respective iterations performed in accordance with the operation associated with the block 620.

The method 600 continues by generating a multi-cell channel estimate corresponding to the plurality of cells during the plurality of iterations, as shown in a block 630.

Referring to method 700 of FIG. 7, the method 700 begins by operating at least one wireless interface of a communication device to support communications with at least one additional communication device via a plurality of cells, as shown in a block 710. The method 700 continues by generating a multi-cell channel estimate corresponding to the plurality of cells during a plurality of iterations, as shown in a block 720.

The method 700 then operates by operating using a time domain (TDOM) per-tap serial interference cancellation (SIC) basis in a first one or more of the plurality of iterations, as shown in a block 730. The method 700 continues by operating using a frequency domain (FDOM) per-cell SIC basis in a second one or more of the plurality of iterations, as shown in a block 740.

With respect to the operations associated with the block 730 and 740, respectively, it is noted that one or more iterations may be respectively performed in accordance with each of the blocks 730 and 740. In some embodiments, a singular iteration is performed in accordance with the operation associated with a block 730, and two or more iterations are performed in accordance with the operation associated with the block 740.

In some alternative embodiments, the operations associated with the block 730 and 740 may be viewed as being sub-steps associated with the operation associated with the block 720.

Generally speaking, at least one preferred embodiment of overall multi-cell channel estimation can be described as follows. Referring to method 800 of FIG. 8, the method 800 may begin operation, as shown in a block 801, by firstly extracting the received mid-amble from the received one slot data. For example, such operation may be totally to extract 256 samples and discard the first 32 samples. Then, as shown in a block 812, the method operates by generating the mid-amble status information for all cells based on the pre available information including mid-amble allocation mode, channelization code spreading factor (SF), and channelization code usage information for the desired UE.

Next, the method 800 operates by performing straight forward lest squares (LS) channel estimation (e.g., based on fast Fourier transform (FFT) for all cells), as shown in a block 814. Then, the method operates by applying the single cell initial noise power estimation, noise reduction, and active mid-amble detection to the individual cells, as shown in a block 814. After that, the cell with the max CIR power is found and noise power estimation refinement is performed based on the reconstructed mid-amble of the strongest cell, as shown in a block 818. Next, the interference cell power is compared with the desired cell power and noise power to decide if there are interferer cells present, as shown in a block 818.

If it is only the desired cell, then the method 800 operates by going with single cell channel estimation, as shown in a block 820. Otherwise, the method 800 operates by performing multi-cell channel estimation. For the multi-cell channel estimation path, the method 800 operates by further ranking the individual channel tap power across all cells to prepare for the per-tap serial interference cancellation (SIC), as shown in a block 822. Then, the method operates by performing per-tap SIC channel estimation for all cells as the first iteration of SIC, as shown in a block 824.

As mentioned elsewhere herein, the per-tap SIC has the better convergence performance than per-cell SIC so it may be employed in the first iteration in such a preferred embodiment. Next, the method 800 operates by performing single cell noise reduction, active mid-amble detection, and mid-amble average for the desired cell, as shown in a block 826.

Also, noise power estimation may be performed based on the reconstructed mid-amble of desired cell, as shown in a block 828. Based on the new updated noise power estimate, the method 800 operates by repeating the single cell noise reduction and active mid-amble detection for all active cells, as shown in a block 830. After the first SIC iteration, the method 800 operates by performing per-cell SIC for a following one or more iterations. However, the method 800 may perform an early termination check first, as shown in a block 832. To perform such an early termination check, the method 800 ay operate by comparing the interferer cells powers with the desired cell power and noise power to decide whether to continue SIC or not, as shown in a block 832.

If it is determined to terminate SIC, the method 800 operates by going directly to the output channel estimate stage (e.g., proceeding to block 846 followed by block 848). Otherwise, the method 800 continues to the next iteration. In order to facilitate the following per-cell SIC, the method 800 also operates by ranking the powers of all valid cells, as shown in a block 832. The per-cell SIC is performed in the frequency domain, so firstly, conversion may be made from all of the channel estimates of interferer cells to the frequency domain, as shown in a block 834. In one per-cell SIC iteration, the method 800 starts with the strongest cell to do noise reduction, active mid-amble detection, and mid-amble average, as shown in a block 836. Then, the method 800 operates by performing the noise power estimation based on reconstructed mid-amble, as shown in a block 836. After that the method 800 operates by performing per-cell SIC to cancel the interference of the strongest cell to other cells, as shown in a block 840. Then, the method 800 operates by repeating the above operations through until the weakest cell.

To finish one per-cell SIC operation, the method 800 operates by performing early termination or max termination check again, as shown in a block 842. During the check, the method 800 also operates to rank the cells powers. If at least one more SIC iteration is still needed, the method 800 operates to repeat above per-cell SIC process. Otherwise, the method 800 operates to perform final noise reduction, active mid-amble detection, and mid-amble average for all cells, as shown in a block 844. Then, the method 800 operates to output the channel estimate based on the interface with a joint detection (JD) module. Finally, the method 800 operates by generating the inter-symbol interference (ISI) generated by the mid-amble due to the multi-path fading channel for use by a joint detection (JD) module (e.g., such for a JD within a communication device), as shown in a block 848.

It is also noted that the various operations and functions as described with respect to various methods herein may be performed within a variety of types of communication devices, such as using one or more processors, processing modules, etc. implemented therein, and/or other components therein including one of more baseband processing modules, one or more media access control (MAC) layers, one or more physical layers (PHYs), and/or other components, etc.

In some embodiments, such a processor, circuitry, and/or a processing module, etc. (which may be implemented in the same device or separate devices) can perform such processing to generate signals for communication with other communication devices in accordance with various aspects of the invention, and/or any other operations and functions as described herein, etc. or their respective equivalents. In some embodiments, such processing is performed cooperatively by a first processor, circuitry, and/or a processing module, etc. in a first device, and a second first processor, circuitry, and/or a processing module, etc. within a second device. In other embodiments, such processing is performed wholly by a processor, circuitry, and/or a processing module, etc. within a singular communication device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An apparatus, comprising:
at least one wireless interface to support communications with at least one additional communication device via a plurality of cells; and
a processor to generate a multi-cell channel estimate corresponding to the plurality of cells during a plurality of iterations, wherein:
the processor to operate using a time domain per-tap serial interference cancellation (SIC) basis in a first of the plurality of iterations; and
the processor to operate using a frequency domain per-cell serial interference cancellation (SIC) basis in a second of the plurality of iterations;
based on a comparison of at least one power of at least one interferer cell with at least one power of at least one other of the plurality of cells, the processor adaptively either to:
generate the multi-cell channel estimate from the second of the plurality of iterations; or
operate using the frequency domain per-cell basis in a third of the plurality of iterations and to generate the multi-cell channel estimate from the third of the plurality of iterations.

2. The apparatus of claim 1, wherein:
the plurality of cells being within a time division synchronous code division multiple access (TD-SCDMA) communication system.

3. The apparatus of claim 1, wherein:
the processor to perform interference cancellation with respect to at least one of the plurality of cells using the multi-cell channel estimate.

4. The apparatus of claim 1, wherein:
the processor to determine whether to perform single cell channel estimation or multi-cell channel estimation based on analysis of a signal received via the at least one wireless interface;
when the multi-cell channel estimation is determined, the processor to generate the multi-cell channel estimate; and
when the single cell channel estimation is determined, the processor to generate a single cell channel estimate.

5. The apparatus of claim 1, wherein:
the apparatus being an access point (AP); and
the at least one additional communication device being a wireless station (STA).

6. An apparatus, comprising:
at least one wireless interface to support communications with at least one additional communication device via a plurality of cells; and
a processor to generate a multi-cell channel estimate corresponding to the plurality of cells during a plurality of iterations, wherein:
the processor to operate using a time domain per-tap serial interference cancellation (SIC) basis in a first of the plurality of iterations; and
the processor to operate using a frequency domain per-cell serial interference cancellation (SIC) basis in a second of the plurality of iterations.

7. The apparatus of claim 6, wherein:
the processor to operate using the frequency domain per-cell basis in a final of the plurality of iterations following the second of the plurality of iterations.

8. The apparatus of claim 6, wherein:
the processor adaptively to operate using the frequency domain per-cell basis in a third of the plurality of iterations based on a comparison of at least one power of at least one interferer cell with at least one power of at least one other of the plurality of cells; and
the processor to generate the multi-cell channel estimate from the third of the plurality of iterations.

9. The apparatus of claim 6, wherein:
the processor adaptively to generate the multi-cell channel estimate from the second of the plurality of iterations based on a comparison of at least one power of at least one interferer cell with at least one power of at least one other of the plurality of cells.

10. The apparatus of claim 6, wherein:
the plurality of cells being within a time division synchronous code division multiple access (TD-SCDMA) communication system.

11. The apparatus of claim 6, wherein:
the processor to perform interference cancellation with respect to at least one of the plurality of cells using the multi-cell channel estimate.

12. The apparatus of claim 6, wherein:
the processor to determine whether to perform single cell channel estimation or multi-cell channel estimation based on analysis of a signal received via the at least one wireless interface;
when the multi-cell channel estimation is determined, the processor to generate the multi-cell channel estimate; and
when the single cell channel estimation is determined, the processor to generate a single cell channel estimate.

13. The apparatus of claim 6, wherein:
the apparatus being an access point (AP); and
the at least one additional communication device being a wireless station (STA).

14. A method for operating a communication device, the method comprising:
operating at least one wireless interface of the communication device to support communications with at least one additional communication device via a plurality of cells;
generating a multi-cell channel estimate corresponding to the plurality of cells during a plurality of iterations;
operating using a time domain per-tap serial interference cancellation (SIC) basis in a first of the plurality of iterations; and
operating using a frequency domain per-cell serial interference cancellation (SIC) basis in a second of the plurality of iterations.

15. The method of claim 14, further comprising:
adaptively operating using the frequency domain per-cell basis in a third of the plurality of iterations based on a comparison of at least one power of at least one interferer cell with at least one power of at least one other of the plurality of cells; and
generating the multi-cell channel estimate from the third of the plurality of iterations.

16. The method of claim 14, further comprising:
adaptively generating the multi-cell channel estimate from the second of the plurality of iterations based on a comparison of at least one power of at least one interferer cell with at least one power of at least one other of the plurality of cells.

17. The method of claim 14, wherein:
the plurality of cells being within a time division synchronous code division multiple access (TD-SCDMA) communication system.

18. The method of claim 14, further comprising:
performing interference cancellation with respect to at least one of the plurality of cells using the multi-cell channel estimate.

19. The method of claim 14, further comprising:
determining whether to perform single cell channel estimation or multi-cell channel estimation based on analysis of a signal received via the at least one wireless interface;
when the multi-cell channel estimation is determined, generating the multi-cell channel estimate; and
when the single cell channel estimation is determined, generating a single cell channel estimate.

20. The method of claim 14, wherein:
the communication device being an access point (AP); and
the at least one additional communication device being a wireless station (STA).
